(19) United States
(12) Patent Application Publication
(10) Pub. No.: US 2026/0306939 A1
(43) Pub. Date: Oct. 8, 2026

(54) Immersive Full-Body Game Control Systems and Methods

(71) Applicant: Carlos Barcelo, Los Alamitos, CA (US)

(72) Inventor: Carlos Barcelo, Los Alamitos, CA (US)

(21) Appl. No.: 19/639,386

(22) Filed: Apr. 6, 2026

Related U.S. Application Data
(60) Provisional application No. 63/783,981, filed on Apr. 5, 2025.

(51) Int. Cl. A63F 13/245; A63F 13/22; A63F 13/52; A63F 13/69

(52) U.S. Cl. CPC A63F 13/245; A63F 13/22; A63F 13/52; A63F 13/69

(57) ABSTRACT

Immersive gaming systems and methods are disclosed. A physical enclosure is configured to resemble a real-world environment, with input devices disposed therein having an outward appearance simulating functional elements native to the environment while internally coupling to sensors that generate electrical signals responsive to user interaction. A processing unit converts the signals to data, and a computer maps the data to in-game actions based on a configurable input mapping, rendering a game environment on a display. In embodiments, the enclosure comprises a shower enclosure with rotary controls disguised as shower knobs coupled to potentiometers via custom adapters, and pushbutton controls disguised as soap dispensers concealing momentary push-button switches. The configurable input mapping supports multiple game genres using the same physical interface without hardware modification. Optional subsystems include a concealed projector for projecting interactive visual elements onto physical objects, a color sensor and actuator for color-based puzzle challenges with hidden mechanical reveals, and output devices producing physical environmental effects coordinated with game events.

### CROSS-REFERENCE TO RELATED APPLICATIONS

This application claims the benefit of U.S. Provisional Application No. 63/783,981, filed Apr. 5, 2025, entitled “Immersive Full-Body Game Control Systems and Methods,” the entire disclosure of which is incorporated herein by reference.

### FIELD OF THE INVENTION

The present invention relates generally to interactive entertainment systems and methods, and more specifically to systems and methods for controlling video games and other interactive experiences using full-body input devices. Even more specifically, the present invention pertains to immersive full-body game control systems that utilize input devices disguised as and simulating the function of real-world everyday objects, such as those found in a shower enclosure, to provide a unique and engaging gaming experience. The invention further encompasses the integration of sensory feedback including visual displays, audio output, special effects, projection mapping, color-based sensing, and escape-room-style puzzle mechanics.

### BACKGROUND OF THE INVENTION

Traditional video game controllers have evolved significantly since the introduction of the joystick and button interfaces of early arcade games. From simple directional pads to complex gamepads with multiple analog sticks, triggers, and buttons, input devices have become increasingly sophisticated, allowing for more nuanced control within virtual environments. However, these advancements have primarily focused on hand-held devices, limiting the player's physical interaction with the game world. This limitation has spurred innovation in alternative controller designs, aiming to create more immersive and engaging experiences.

One prominent area of development has been in the realm of racing simulators. These setups often include a steering wheel, pedals, and sometimes a gear shifter, providing a more realistic driving experience. More advanced simulators incorporate motion platforms that physically move the player, mimicking the sensations of acceleration, braking, and cornering. While these systems offer a greater degree of immersion than traditional controllers, they are often expensive and require dedicated space, limiting their accessibility to a niche market.

Furthermore, these simulators are primarily designed for specific genres, such as racing, and lack the versatility to be easily adapted to other types of games.

Beyond racing simulators, other attempts at full-body gaming experiences have explored motion capture technologies. These systems allow players to control games with their body movements, offering a more intuitive and physically active form of interaction. However, the range of games specifically designed for these motion capture systems remains relatively limited.

Despite these advancements, a need remains for a versatile, creative, and accessible full-body gaming experience. Current solutions often lack the flexibility to be used across a wide range of game genres, or suffer from technical limitations.

There exists a need for additional innovations in the art. It is therefore desirable to address the limitations in the known art by means of the systems and methods described herein.

### BRIEF DESCRIPTION OF THE DRAWINGS

Reference is made to the accompanying exemplary drawings, which are not to scale.

FIG. 1 is an exemplary block diagram of a computing system that may be used to implement aspects of certain embodiments of the present invention.

FIG. 2 depicts an exemplary networked environment in which systems and methods, consistent with exemplary embodiments of the present invention, may be implemented.

FIG. 3 illustrates the overall architecture of an embodiment of an immersive full-body game control system 300 according to aspects of the present invention.

FIG. 4 depicts the physical layout of a modified shower enclosure 310 according to an embodiment of the present invention, showcasing the integration of the game controls within a realistic shower environment.

FIG. 5 provides detailed views of modified shower controls according to an embodiment of the present invention, illustrating the internal mechanisms that connect the user's physical interactions to the game system.

FIG. 6 illustrates the connections and data flow between the sensors located within the shower enclosure 310, the development board 340, and the game computer 350, according to an embodiment of the present invention.

FIG. 7 illustrates the software components of the immersive full-body game control system 300 according to an embodiment of the present invention, focusing on the interaction between the game engine 352, custom software modules 356, and the communication with the development board 340.

FIG. 8 presents a screenshot or mock-up of the game display as seen by the player within the shower enclosure 310 according to an embodiment of the present invention.

FIG. 9 provides a close-up view of the game display, focusing on the germ-targeting gameplay mechanic according to an embodiment of the present invention.

FIG. 10 depicts immersive special effects integrated into the gameplay, such as steam generation and bubbles, triggered by in-game events, according to an embodiment of the present invention.

FIG. 11 depicts a leaderboard display according to an embodiment of the present invention, showing the cloud interface and community features of the game.

FIG. 12 demonstrates the versatility of the immersive full-body game control system 300 by showcasing its application in an alternative game genre according to an embodiment of the present invention, specifically a first-person shooter.

FIG. 13 further demonstrates the versatility of the immersive full-body game control system 300 by showcasing its application in another alternative game genre according to an embodiment of the present invention, a racing game.

FIG. 14 provides a flowchart illustrating the overall system process according to an embodiment of the present invention, from user input to game output and feedback.

FIG. 15 illustrates the setup of a hidden mini projector 382 and a projection mapping system 380 within the shower enclosure 310 according to an embodiment of the present invention.

FIG. 16 provides a specific example of a projected interface 384 on a physical object according to an embodiment of the present invention, showing a memory game projected onto a shampoo bottle.

FIG. 17 depicts the overall system diagram to include projection mapping components, with the projector hidden within the shower enclosure 310, according to an embodiment of the present invention.

FIG. 18 illustrates the integration of a color sensor 390 into the immersive gaming system according to an embodiment of the present invention.

FIG. 19 provides a specific example of a color-based puzzle within the game, according to an embodiment of the present invention.

FIG. 20 illustrates the activation of a hidden mechanism 394 triggered by the successful completion of a color-based puzzle according to an embodiment of the present invention.

FIG. 21 updates the overall system diagram to include a color sensor 390 and a hidden servo motor 392, according to aspects of the present invention.

### DETAILED DESCRIPTION

Those of ordinary skill in the art will realize that the following description of the present invention is illustrative only and not in any way limiting. Other embodiments of the invention will readily suggest themselves to such skilled persons upon their having the benefit of this disclosure. Reference will now be made in detail to specific implementations of the present invention, as illustrated in the accompanying drawings. The same reference numbers will be used throughout the drawings and the following description to refer to the same or like parts.

Certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions that execute on the computer or other programmable apparatus create structures for implementing the functions specified in the flow chart block or blocks. These computer program instructions may also be stored in computer-readable memory that can direct a computer or other programmable apparatus to function in a particular manner, such that the instructions stored in computer-readable memory produce an article of manufacture including instruction structures that implement the function specified in the flow chart block or blocks. The computer program instructions may also be loaded onto a computer or other programmable apparatus to cause a series of operational steps to be performed on the computer or other programmable apparatus to produce a computer-implemented process such that the instructions that execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems that perform the specified functions or steps, or combinations of special purpose hardware and computer instructions.

For example, any number of computer programming languages, such as C, C++, C #(CSharp), Perl, Ada, Python, Pascal, SmallTalk, FORTRAN, assembly language, and the like, may be used to implement aspects of the present invention. Further, various programming approaches such as procedural, object-oriented or artificial intelligence techniques may be employed, depending on the requirements of each particular implementation. Compiler programs and/or virtual machine programs executed by computer systems generally translate higher-level programming languages to generate sets of machine instructions that may be executed by one or more processors to perform a programmed function or set of functions.

In the descriptions in this document, certain embodiments are described in terms of particular data structures, preferred and optional enforcements, preferred control flows, and examples. Other and further applications of the described methods, as would be understood after review of this application by those with ordinary skill in the art, are within the scope of the claimed invention.

The term “machine-readable medium” should be understood to include any structure that participates in providing data that may be read by an element of a computer system. Such a medium may take many forms, including but not limited to, non-volatile media, volatile media, and transmission media. Non-volatile media include, for example, optical or magnetic disks and other persistent memory such as devices based on flash memory (such as solid-state drives, or SSDs). Volatile media include dynamic random access memory (DRAM) and/or static random access memory (SRAM). Transmission media include cables, wires, and fibers, including the wires that comprise a system bus coupled to a processor. Common forms of machine-readable media include, for example and without limitation, a floppy disk, a flexible disk, a hard disk, a solid-state drive, a magnetic tape, any other magnetic medium, a CD-ROM, a DVD, or any other optical medium.

As used herein, the term “computer system” is defined to include one or more processing devices (such as a central processing unit (“CPU”) or graphics processing unit (“GPU”)) for processing data and instructions that are coupled with one or more data storage devices for exchanging data and instructions with the processing unit, including, but not limited to, RAM, ROM, internal SRAM, on-chip RAM, on-chip flash, CD-ROM, hard disks, and the like.

Examples of computer systems include everything from a controller to a laptop or desktop computer, to a super-computer. The data storage devices can be dedicated, i.e., coupled directly with the processing unit, or remote, i.e., coupled with the processing unit over a computer network. It should be appreciated that remote data storage devices coupled to a processing unit over a computer network can be capable of sending program instructions to the processing unit for execution. In addition, the processing device can be coupled with one or more additional processing devices, either through the same physical structure (e.g., a parallel processor), or over a computer network (e.g., a distributed processor.). The use of such remotely coupled data storage devices and processors will be familiar to those of skill in the computer science arts. The term “computer network” as used herein is defined to include a set of communications channels interconnecting a set of computer systems that can communicate with each other. The communications channels can include transmission media such as, but not limited to, twisted pair wires, coaxial cable, optical fibers, satellite links, or digital microwave radio. The computer systems can be distributed over large, or “wide,” areas (e.g., over tens, hundreds, or thousands of miles, WAN), or local area networks (e.g., over several feet to hundreds of feet, LAN). Furthermore, various local-area and wide-area networks can be combined to form aggregate networks of computer systems.

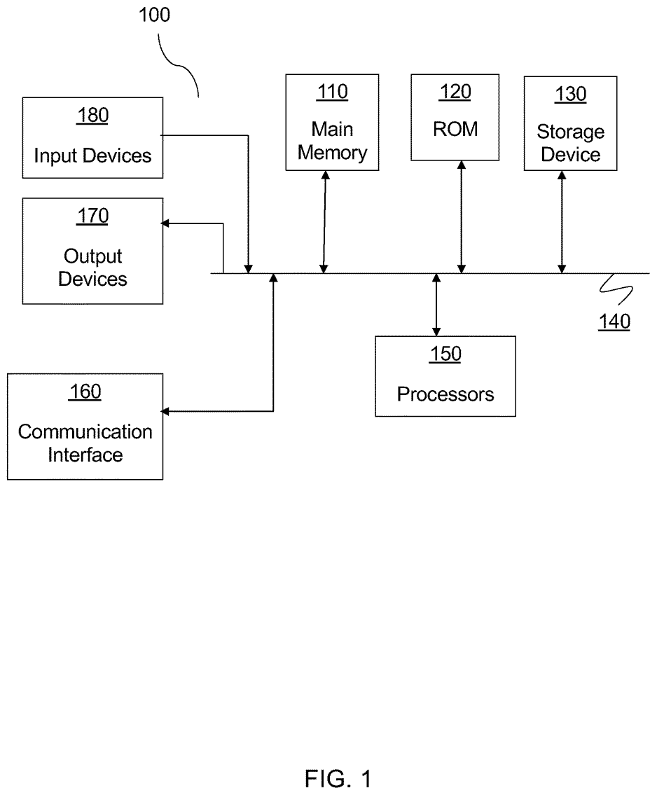

FIG. 1 is an exemplary block diagram of a computing system 100 that may be used to implement aspects of certain embodiments of the present invention. Computing device 100 may include, without limitation, a bus 140, one or more processors 150, main memory 110, a read-only memory (ROM) 120, a storage device 130, one or more input devices 180, one or more output devices 170, and a communication interface 160. Bus 140 may include, without limitation, one or more conductors that permit communication among the components of computing device 100.

Processors 150 may include, without limitation, any type of conventional processors, microprocessors, CPUs, GPUs, or processing logic that interprets and executes instructions.

Main memory 110 may include, without limitation, a random-access memory (RAM) or another type of dynamic storage device that stores information and instructions for execution by processors 150. ROM 120 may include, without limitation, a conventional ROM device or another type of static storage device that stores static information and instructions for use by processors 150. Storage device 130 may include, without limitation, a magnetic and/or optical recording medium and its corresponding drive.

Input device(s) 180 may include, without limitation, one or more conventional mechanisms that permit a user to input information to computing device 100, such as a keyboard, a mouse, a pen, a stylus, handwriting recognition, voice recognition, biometric mechanisms, touch screen, and the like. Output device(s) 170 may include, without limitation, one or more conventional mechanisms that output information to the user, including a display, a printer, a speaker, and the like. Communication interface 160 may include, without limitation, any transceiver-like mechanism that enables computing device 100 to communicate with other devices and/or systems. For example, communication interface 160 may include, without limitation, mechanisms for communicating with another device or system via a network.

As described in detail herein, computing device 100 may perform operations based on software instructions that may be read into memory 110 from another computer-readable medium, such as data storage device 130, or from another device via communication interface 160. The software instructions contained in memory 110 cause one or more processors 150 to perform processes that are described elsewhere. Alternatively, hardwired circuitry may be used in place of, or in combination with, software instructions to implement processes consistent with the present invention. Thus, various implementations are not limited to any specific combination of hardware circuitry and software.

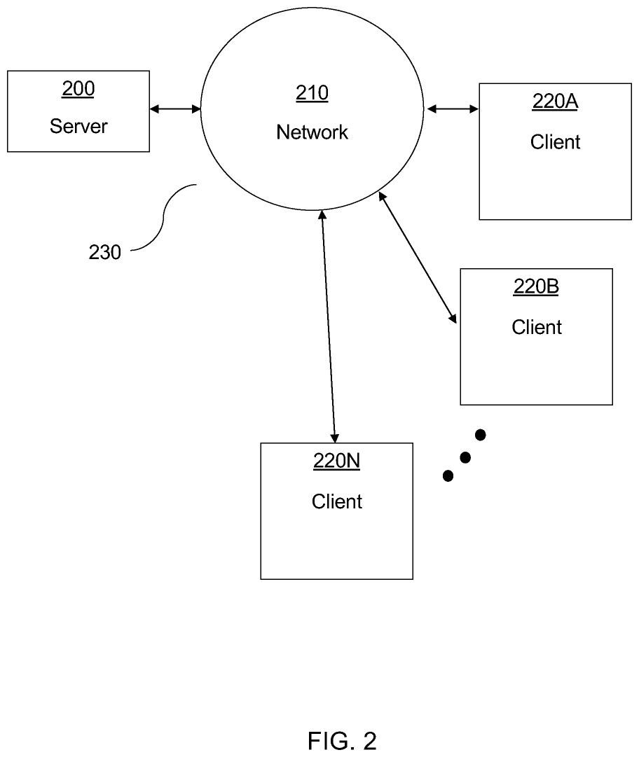

FIG. 2 depicts an exemplary networked environment 230 in which systems and methods, consistent with exemplary embodiments of the present invention, may be implemented. As illustrated, networked environment 230 may include, without limitation, a server (200), one or more clients (220A-220N), and a network (210). The exemplary simplified number of servers (200), clients (220A-220N), and networks (210) illustrated in FIG. 2 can be modified as appropriate in a particular implementation. In practice, there may be additional servers (200), clients (220), and/or networks (210).

In certain embodiments, a client 220 may connect to network 210 via wired and/or wireless connections, and thereby communicate or become coupled with server 200, either directly or indirectly. Alternatively, client 220 may be associated with server 200 through any suitable tangible computer-readable media or data storage device (such as a disk drive, CD-ROM, DVD, or the like), data stream, file, or communication channel.

Network 210 may include, without limitation, one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, a cellular network, and/or another type of suitable network, depending on the requirements of each particular implementation.

One or more components of networked environment 230 may perform one or more of the tasks described as being performed by one or more other components of networked environment 230.

Details regarding the foregoing components (e.g., as depicted in FIGS. 1 and 2), which may be implemented in a single computing device or distributed among multiple computing devices, are described throughout this document.

Certain embodiments address current limitations in the art by providing a novel full-body interactive game controller system that is adaptable and immersive, and that leverages familiar real-world interfaces, such as shower controls, to create a unique and engaging gaming experience.

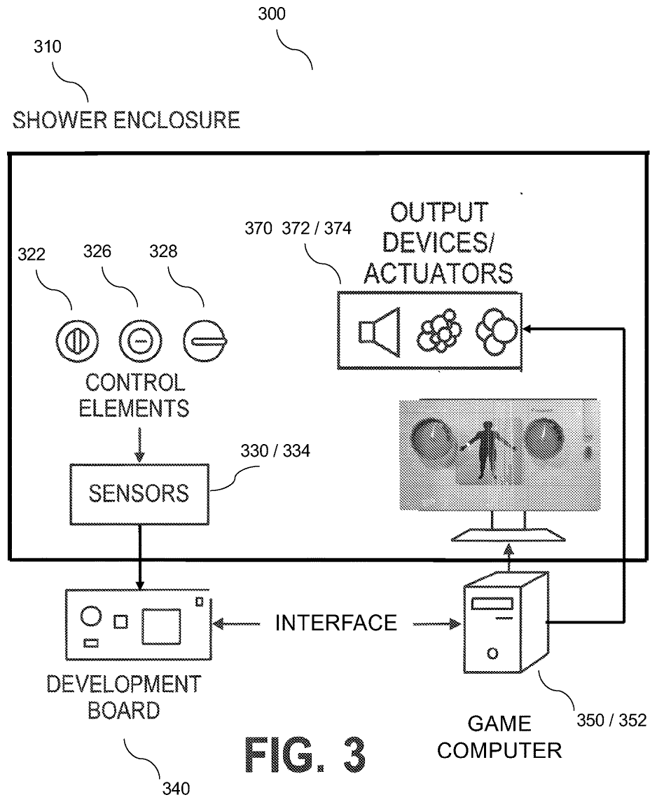

FIG. 3 illustrates the overall architecture of an embodiment of an immersive full-body game control system 300 according to aspects of the present invention. The diagram depicts the interaction between the physical components within the modified shower enclosure 310, the processing unit, the game computer 350, and the output devices.

The processing unit may be implemented as a commercially-available microcontroller development board 340, from vendors such as Arduino. These boards vary in processing power, connectivity (Wi-Fi, Bluetooth), size, and intended use cases, from beginner-friendly platforms to more advanced professional prototyping tools. The choice of development board 340 or boards depends on the particular requirements of each implementation, as skilled artisans will readily recognize.

Within the shower enclosure 310, the user interacts with various control elements, including the temperature and pressure knobs 322, the shower/tub diverter 326, and the soap dispenser buttons 328. These controls are physically coupled to sensors, such as potentiometers 330 for the knobs and momentary push-button switches 334 for the dispensers. These sensors translate the user's physical actions into electrical signals.

The signals from the sensors are then routed to a development board 340. The development board 340 acts as an intermediary, reading the sensor data and processing it into a format suitable for the game computer 350. The development board 340 communicates with the computer, typically via a USB connection, transmitting the processed control information.

The game computer 350, running a game engine 352 such as Unreal Engine, receives the control data from the development board 340. It may be implemented as computer system 100 as shown in FIG. 1. The game engine 352 interprets this data and uses it to control the game environment displayed on the monitor within the shower enclosure 310. The computer also manages other output devices and actuators.

In addition to the visual display, the system includes speakers 370 for audio feedback and DMX-controlled smoke and bubble machines 372, 374 to provide immersive physical effects. These effects, such as steam generation for high virtual temperatures, are triggered by events within the game, enhancing the overall immersive experience. The computer sends control signals to these output devices, coordinating them with the game action. FIG. 3 thus provides a high-level overview of the system's components and their interconnections in certain embodiments, illustrating the flow of information and control within the immersive full-body game controller. According to certain embodiments, real world objects (or replicas of them) appear and function as in their ordinary use (e.g., a shower handle or soap dispenser button 328) but their primary function in the system is game control, actuation, and/or user interaction.

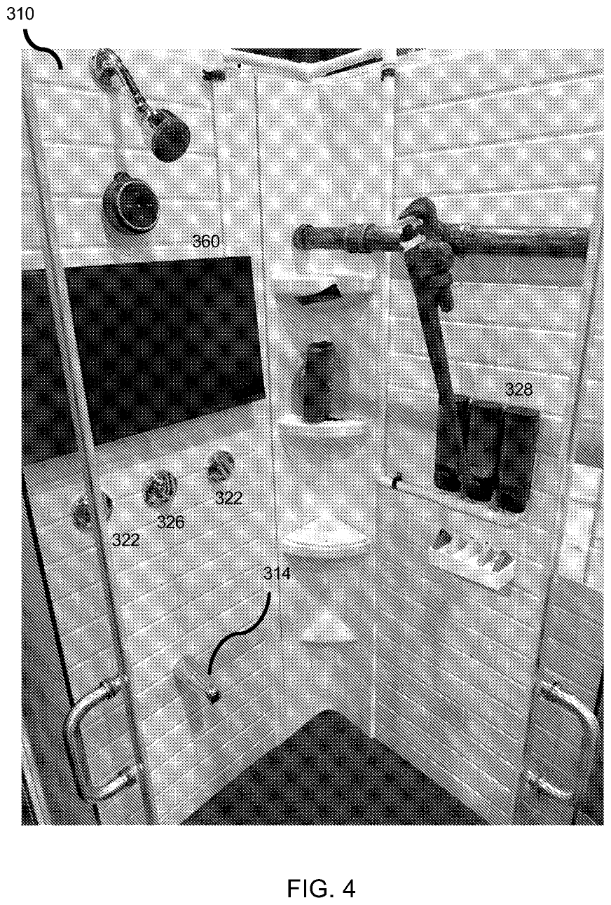

FIG. 4 depicts the physical layout of a modified shower enclosure 310 according to an embodiment of the present invention, showcasing the integration of the game controls within a realistic shower environment. The illustration depicts the enclosure, showing the outward appearance of the various control elements.

The figure depicts the familiar aesthetic of a standard shower. A showerhead 312 is positioned overhead, and a tub spout 314 is located near the bottom. Hot and cold water temperature knobs 322, a diverter knob 326 to switch between the showerhead 312 and tub spout 314, and a water pressure knob 322 are all visibly integrated into the shower fixture. These controls, while appearing functional for a regular shower, are secretly coupled to sensors for game input.

Wall-mounted push-button soap dispensers 328 are also shown. These dispensers, seemingly intended for dispensing soap, act as input buttons for the game, similar to the buttons on a traditional gamepad. A pipe with a large nut (controllable manually or via a wrench, as shown), designed to appear as a water pressure regulator, is also visible and may serve as an additional control element.

A display monitor 360 is mounted within the shower enclosure 310, visible to the user. This monitor displays the game visuals, providing feedback to the player based on their interactions with the shower controls. Speakers, integrated into the enclosure or placed strategically, provide audio feedback. The shower doors are shown, completing the shower enclosure 310 setup.

FIG. 4 shows the system's design, depicting its integration within a familiar and believable shower environment. The user interacts with the game through seemingly ordinary shower controls, enhancing the immersive and unique nature of the full-body gaming experience.

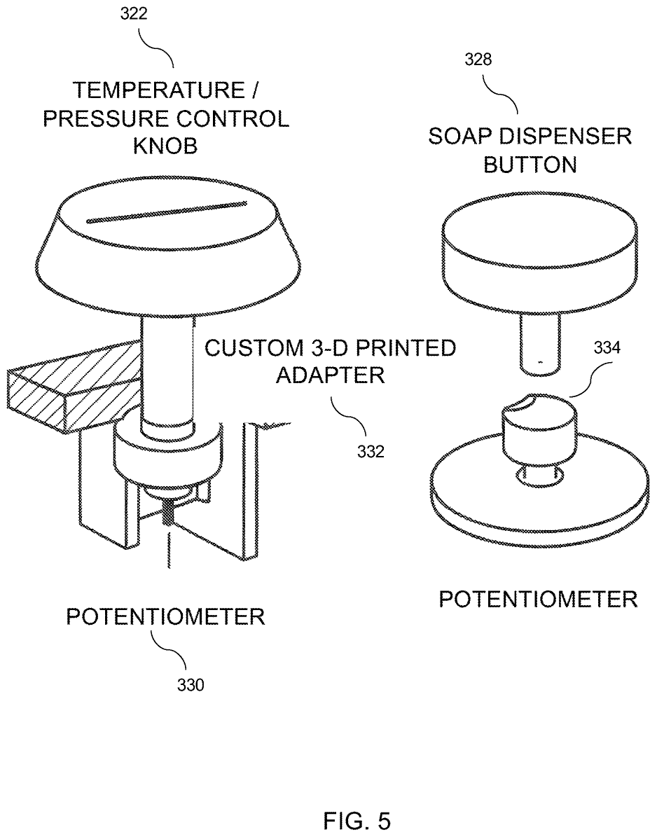

FIG. 5 provides detailed views of modified shower controls according to an embodiment of the present invention, illustrating the internal mechanisms that connect the user's physical interactions to the game system. FIG. 5 includes views of temperature/pressure knobs 322 and soap dispenser buttons 328, revealing how they are coupled to sensors.

The view of a temperature/pressure knob 322 depicts how the rotation of the knob is mechanically linked to a potentiometer 330. As the user turns the knob, the potentiometer 330's resistive element changes, generating a variable electrical signal that corresponds to the knob's position. This signal represents the desired temperature or pressure setting within the game. The figure depicts how the knob maintains its outward appearance of a standard shower control, concealing the underlying sensor mechanism.

A custom three-dimensional (3-D) printed adapter 332 is shown coupling the knob to the potentiometer 330 shaft. The adapter is specifically designed to mate with the existing knob geometry while providing a secure mechanical connection to the potentiometer 330. This custom adapter enables the use of realistic, off-the-shelf shower knobs while ensuring precise and repeatable sensor actuation.

The view of a soap dispenser button 328 reveals a momentary push-button switch 334 located behind the button's facade. When the user presses the button, the switch is activated, generating a distinct electrical signal. This signal is interpreted by the game system as a button press, triggering a specific action within the game, such as launching a virtual germ. The figure shows how the button retains its appearance as a soap dispenser 328 while functioning as a game input.

FIG. 5 also includes details about the materials used, the mounting of the sensors, and the overall construction of the modified controls. This figure depicts how the familiar shower controls are adapted to serve as precise and reliable input devices for the immersive game system. It shows the integration of sensor technology within the existing shower fixture, maintaining the illusion of a standard shower while providing a novel gaming experience.

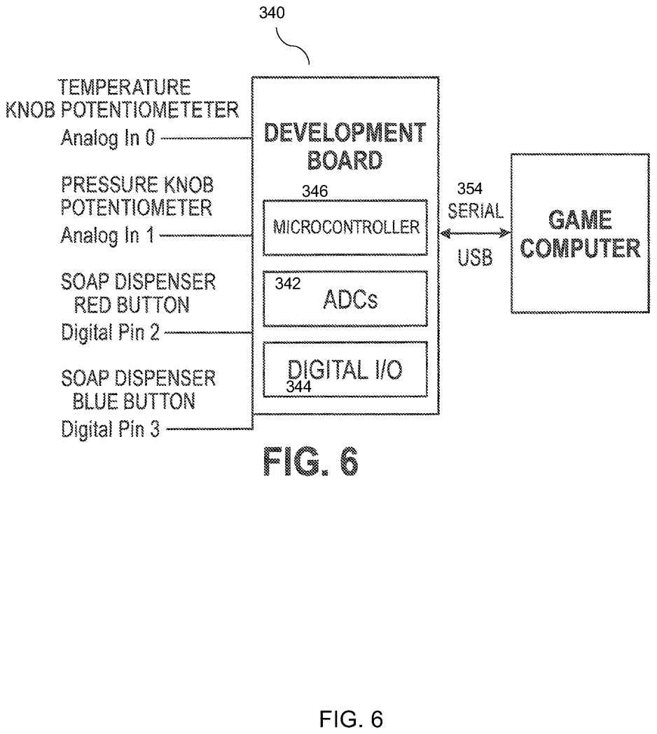

FIG. 6 illustrates the connections and data flow between the sensors located within the shower enclosure 310, the development board 340, and the game computer 350, according to an embodiment of the present invention. The diagram provides a clear view of the signal paths and the role of the development board 340 as an intermediary between the physical controls and the game software.

The figure depicts multiple connections between the sensors (potentiometers 330 for the knobs, push-button switches 334 for the dispensers) and the development board 340. Each sensor is connected to a specific input pin on the development board 340. The diagram labels these connections, indicating the type of sensor and the corresponding development board 340 pin. For example, “Temperature Knob Potentiometer—Analog In 0 ,” “Pressure Knob Potentiometer—Analog In 1,” “Soap Dispenser Red Button-Digital Pin 2,” and “Soap Dispenser Blue Button Digital Pin 3.”

The development board 340 is depicted with its various components, including the microcontroller 346, analog-to-digital converters 342 (ADCs 342), and digital input/output pins 344. The diagram illustrates how the analog signals from the potentiometers 330 are converted to digital values by the development board 340's ADC. The digital signals from the push-button switches 334 are read directly by the development board 340's digital input pins.

The figure also depicts the connection between the development board 340 and the game computer 350, typically via a USB cable 354. This connection allows the development board 340 to transmit the processed sensor data to the computer. The diagram indicates the communication protocol used, such as serial communication.

FIG. 6 depicts the development board 340's role in collecting and processing the raw sensor data before it is sent to the game computer 350. This processing may include scaling the analog values from the potentiometers 330 to a suitable range, debouncing the push-button signals, and packaging the data into a format that the game software can understand. This diagram depicts the hardware interface and data flow within the system, showing the development board 340's function as a bridge between the physical controls and the virtual game environment.

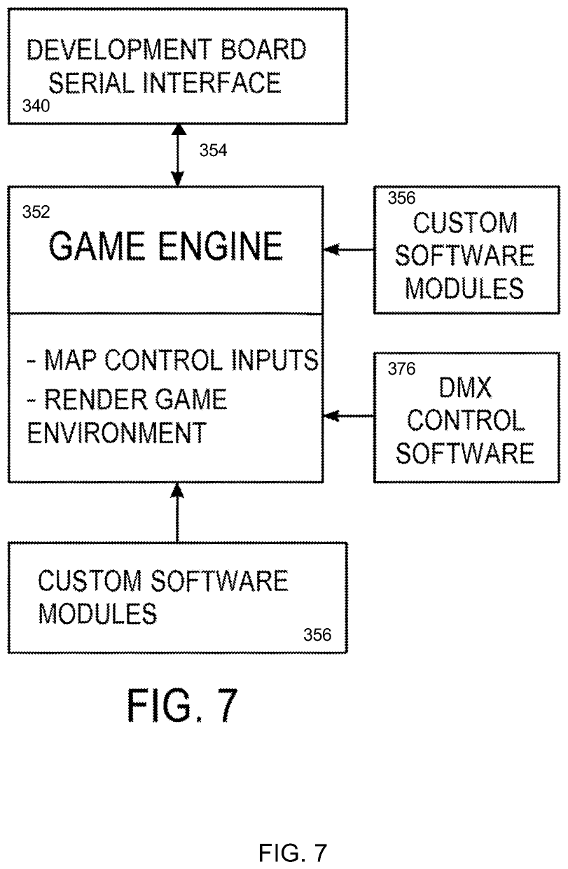

FIG. 7 illustrates the software components of the immersive full-body game control system 300 according to an embodiment of the present invention, focusing on the interaction between the game engine 352, custom software modules 356, and the communication with the development board 340. The diagram provides a high-level view of the software running on the game computer 350.

In certain embodiments, the central element of the software architecture is the game engine 352, depicted prominently in the figure. Unreal Engine, or another suitable game engine 352, is shown as the core platform. The figure shows the engine's role in rendering the game environment, managing game logic, and handling user input.

The diagram depicts the interface between the game engine 352 and the development board 340. This connection, often through a serial communication library 354 or plugin, allows the game engine 352 to receive the processed sensor data from the development board 340. The figure illustrates how the game engine 352 interprets this data, mapping the physical control inputs to in-game actions. For example, the rotation of the temperature knob 322 might control the virtual water temperature, and the pressing of a soap dispenser button 328 might trigger the launch of a virtual germ. The game engine 352 supports a configurable input mapping that associates each physical control signal with a selectable in-game action, allowing the same physical controls to be remapped for different game genres or modes without hardware modification.

FIG. 7 also depicts custom software modules 356, showing their interaction with the game engine 352. These modules may handle specific aspects of the game logic in certain embodiments, such as the germ-targeting gameplay, the physics of the virtual shower, or the communication with the cloud-based leaderboard 400. The diagram shows how these modules integrate with the game engine 352 to create the complete gaming experience.

FIG. 7 also depicts the connection to the DMX control software 376, which manages the smoke and bubble machines 372, 374. This software receives commands from the game engine 352, triggering the special effects based on in-game events. The figure depicts the integration of the special effects with the game, enhancing the immersive experience.

This figure provides an overview of the software components and their interactions, showing how the sensor data from the development board 340 is used to control the game and trigger feedback through the various output devices. It shows the role of the game engine 352 as the central platform and the integration of custom modules and external control software.

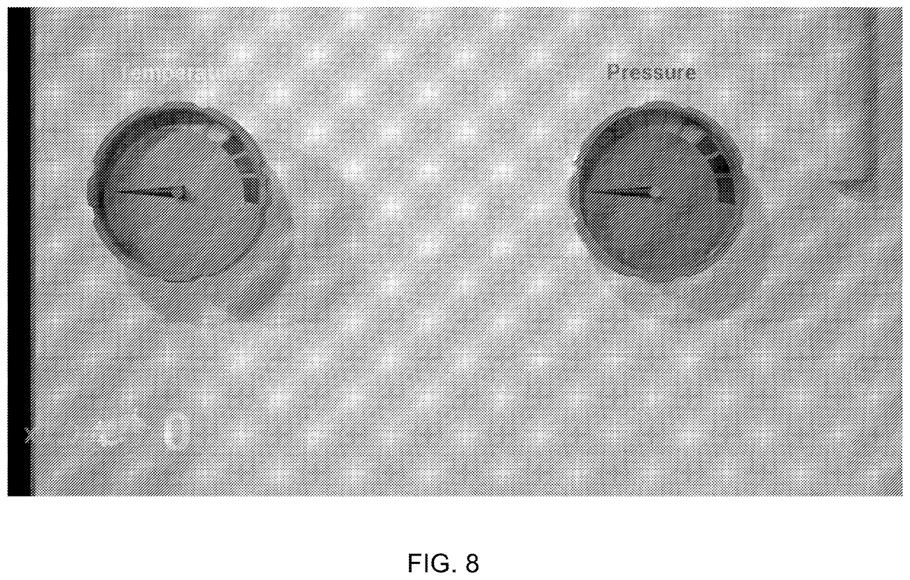

FIG. 8 presents a screenshot or mock-up of the game display as seen by the player within the shower enclosure 310 according to an embodiment of the present invention. It focuses on the virtual shower environment and the information presented to the player during gameplay.

The figure depicts a virtual representation of the shower enclosure 310 setup, mirroring the physical setup in which the player is located. The virtual shower includes elements such as a virtual showerhead 312, tub spout 314, temperature and pressure displays, and representations of the physical controls (knobs, dispensers). This visual correspondence between the real and virtual environments reinforces the immersive nature of the system. The figure shows the information displayed to the player. The temperature and pressure readouts, mirroring the settings of the physical knobs, are clearly visible. These readouts provide feedback to the player, allowing them to fine-tune the virtual shower environment. A score bar or display is also shown, indicating the player's progress in the game.

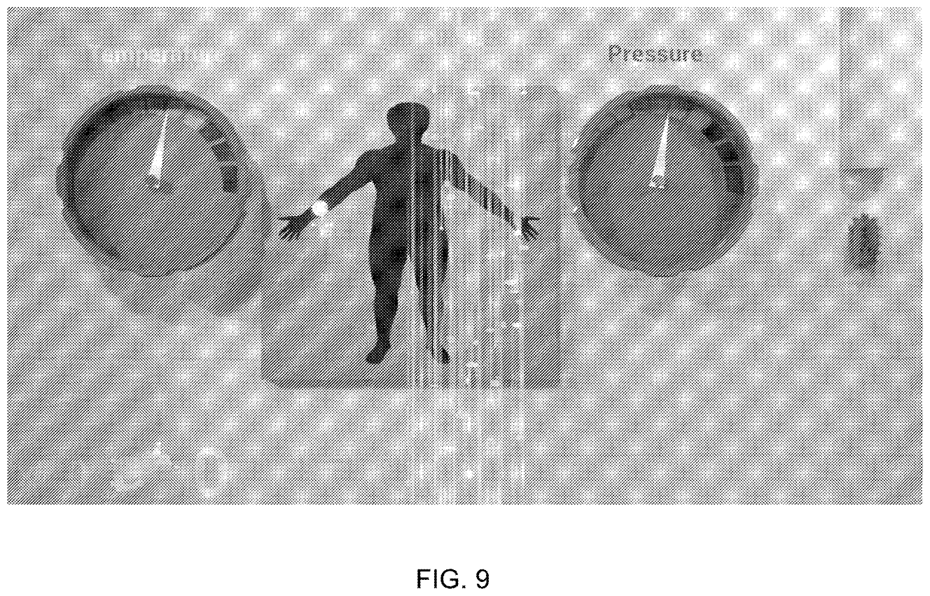

The figure (see also FIG. 9) also depicts virtual germs or other game elements within the virtual shower. This provides context for the gameplay, illustrating how the player interacts with the virtual environment using the physical controls. For example, the figure could show virtual germs moving through the virtual pipes, approaching a target area.

FIG. 9 provides another view of the game display, focusing on the germ-targeting gameplay mechanic according to an embodiment of the present invention. It depicts the timing aspect of the game and the player's interaction with the virtual germs.

The figure depicts a view of the virtual germs as they move through the virtual pipes or towards a target area on the screen. The germs are visually distinct, perhaps with different colors or shapes, corresponding to the different soap dispensers 328. The figure depicts a threshold or target area on the screen, indicating where the player needs to interact with the germs.

The figure depicts the timing element of the gameplay. It depicts the germs approaching the threshold and shows the precise moment when the player needs to activate the corresponding soap dispenser button 328. The figure may include visual cues, such as a highlight or a change in the germ's appearance, indicating the optimal time to press the button.

The figure shows the connection between the virtual germs and the physical soap dispenser buttons 328. It depicts an icon or a visual representation of the corresponding button near the germ, reinforcing the link between the physical action and the in-game event. For example, a red germ might be associated with the red soap dispenser button 328.

This figure focuses on the core gameplay mechanic, showing the player's interaction with the virtual germs and the importance of timing. It depicts how the player uses the physical soap dispenser buttons 328 to target the germs and earn points, showing the rhythm-based and interactive nature of the game. It provides a clear illustration of the challenge and the skill involved in the germ-targeting gameplay.

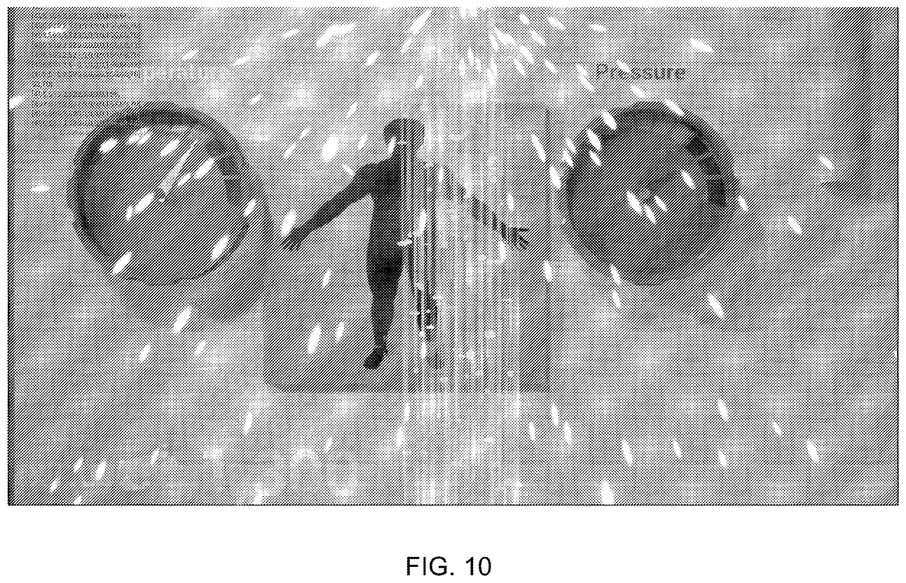

FIG. 10 depicts immersive special effects integrated into the gameplay, such as steam generation and bubbles, triggered by in-game events, according to an embodiment of the present invention. The figure demonstrates how these effects enhance the player's experience and create a more engaging and realistic virtual environment.

The figure depicts the virtual shower with steam emanating from the showerhead 312 or rising from the virtual water. This effect could be triggered by a high virtual water temperature, providing visual feedback to the player about the in-game conditions. The steam should appear realistic and integrate seamlessly with the virtual shower environment.

The figure could also show bubbles appearing in the virtual shower, perhaps associated with the use of a specific virtual soap or triggered by a particular in-game event. The bubbles should add to the visual richness of the game and enhance the sense of immersion.

The figure depicts the role of these special effects in enhancing the player's sense of presence within the game world. It shows how the visual and physical effects are synchronized with in-game events, creating a more believable and engaging experience. This figure demonstrates the system's ability to provide multi-sensory feedback, making the game more immersive and enjoyable.

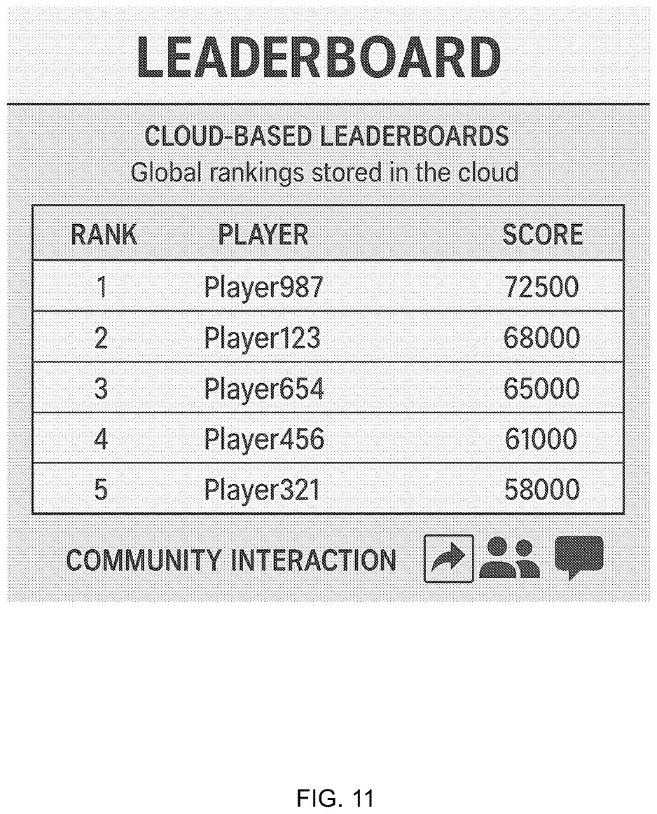

FIG. 11 depicts a leaderboard display according to an embodiment of the present invention, showing the cloud interface and community features of the game. The figure presents a screenshot or mock-up of the leaderboard as it would appear to the player, either on the main game display within the shower enclosure 310 or perhaps on a separate screen.

The figure displays the leaderboard rankings, showing player names or IDs and their corresponding scores. The ranking may be global, showing the top players from around the world, or it may be limited to friends or a specific community. The figure depicts the competitive aspect of the game by displaying the top scores and rankings.

The figure also illustrates the cloud interface. A brief caption or annotation may explain that the leaderboard data is stored and managed in the cloud, enabling global leaderboards and cross-platform access.

The community features are also depicted. This may be shown by icons representing social media integration, friend lists, or in-game messaging. The figure depicts how players can connect with each other, compare scores, and challenge each other to games.

The figure shows the social and competitive aspects of the game, showing how players can track their progress, compare their scores with others, and engage with the game community. It depicts the use of cloud technology to facilitate global leaderboards and community interaction, adding another layer of engagement to the gaming experience.

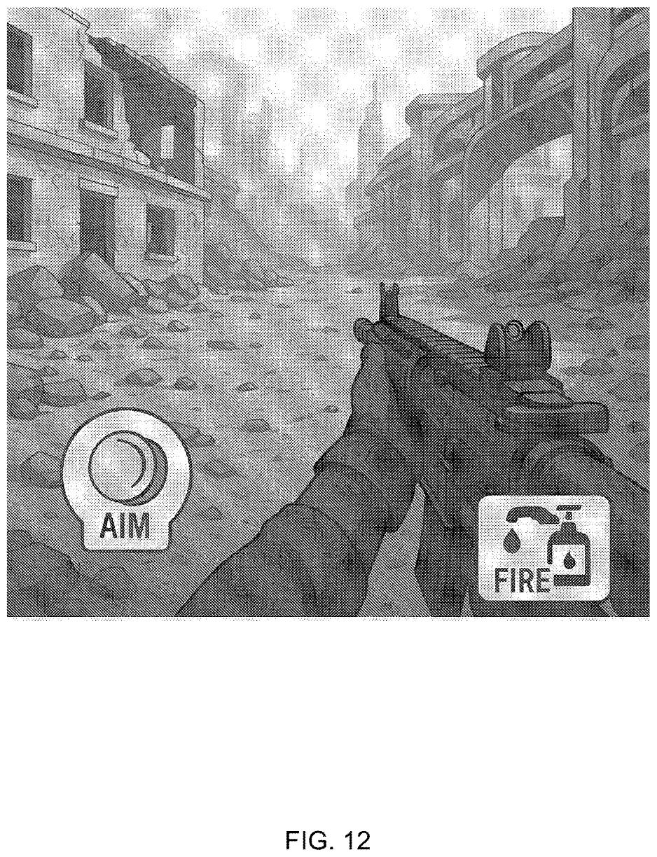

FIG. 12 demonstrates the versatility of the immersive full-body game control system 300 by showcasing its application in an alternative game genre according to an embodiment of the present invention, specifically a first-person shooter (FPS). The figure presents a screenshot or mock-up of the game display showing the FPS game environment, controlled using the same shower enclosure 310 setup.

The figure depicts the in-game perspective of the FPS, showing the player's view of the virtual environment. This could be a typical FPS setting, such as a battlefield, a futuristic cityscape, or an indoor arena. The figure shows that the game is being controlled using the shower controls.

The figure indicates how the shower controls are mapped to FPS actions. For example, it might show a small icon or text overlay indicating that turning the temperature knob 322 controls aiming, while pressing a soap dispenser button 328 fires the weapon. The figure thus shows that the same physical interface is being used for this entirely different game genre.

The figure depicts the adaptability of the system beyond the shower simulation. It demonstrates that the system can be used for a wider range of games, showcasing its potential for various genres, not limited to a single type of game. It depicts the broader applicability of the invention and its potential to create immersive experiences across different game genres.

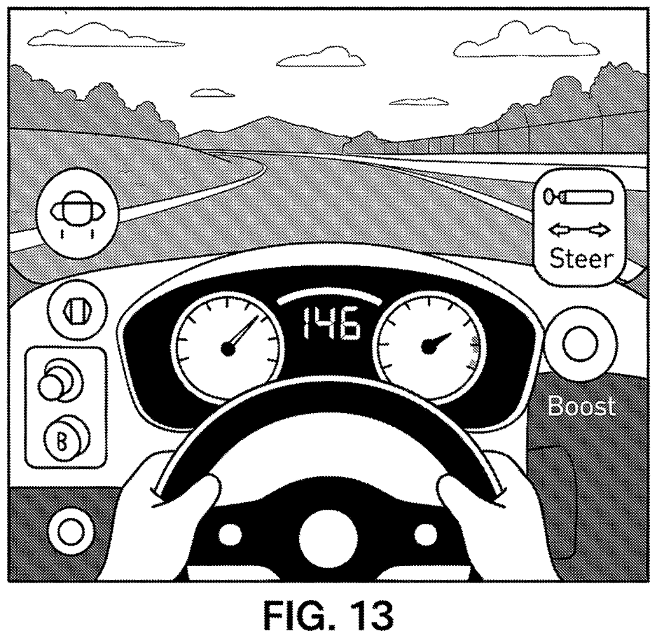

FIG. 13 further demonstrates the versatility of the immersive full-body game control system 300 by showcasing its application in another alternative game genre according to an embodiment of the present invention, a racing game. The figure presents a screenshot or mock-up of the game display showing the racing game environment, controlled using the same shower enclosure 310 setup.

The figure depicts the in-game perspective of the racing game, showing the player's view from the cockpit of a race car or another vehicle. The figure illustrates that this racing game is being controlled using the seemingly unconventional shower controls.

The figure indicates how the shower controls are mapped to racing game actions in certain embodiments. For example, it may show a small icon or text overlay indicating that turning the temperature knob 322 controls steering, while pressing a soap dispenser button 328 activates boost or fires a weapon. The figure should make it clear that the same physical interface is being used for this entirely different game genre. The large pipe nut may be used for gear shifting in certain embodiments.

The figure depicts the adaptability of the system beyond the shower simulation and the FPS example. It further demonstrates that the system can be used for a wide range of games, showcasing its potential for various genres, including racing.

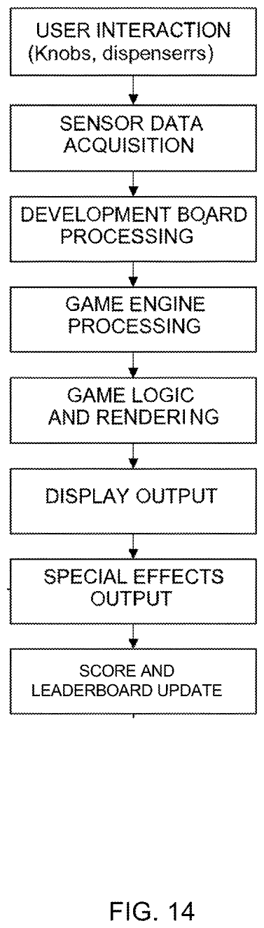

FIG. 14 provides a flowchart illustrating the overall system process according to an embodiment of the present invention, from user input to game output and feedback. It provides a step-by-step visualization of the system's operation, clarifying the sequence of events and the interaction between the different components.

The flowchart begins with the “User Interaction” block, representing the player's physical manipulation of the shower controls (knobs, dispensers). From this block, the flow branches to the “Sensor Data Acquisition” block, where the sensors (potentiometers 330, switches) capture the user's actions and convert them into electrical signals.

The next block, “Development Board Processing,” depicts the development board 340 receiving the sensor data, processing it (e.g., converting analog to digital, debouncing buttons), and preparing it for transmission. The flow then proceeds to “Data Transmission to Computer,” indicating the transfer of the processed data from the development board 340 to the game computer 350, typically via USB.

The “Game Engine Processing” block represents the game computer 350 receiving the data and interpreting it within the game engine 352 (e.g., Unreal Engine). This block depicts the mapping of the control inputs to in-game actions, such as adjusting the virtual shower temperature or launching virtual germs.

The flow continues to “Game Logic and Rendering,” where the game engine 352 updates the game state based on the user input and renders the visual output for the display. The “Display Output” block depicts the game visuals being displayed on the monitor within the shower enclosure 310, providing feedback to the player.

The flowchart also includes a parallel path for “Special Effects Control,” where the game engine 352 triggers the smoke and bubble machines 372, 374 based on in-game events. This path leads to the “Special Effects Output” block, showing the generation of steam and bubbles, further enhancing the immersive experience.

Finally, the flowchart may include a “Score and Leaderboard Update” block, showing the game tracking the player's score and updating the cloud-based leaderboard 400. The flow then loops back to “User Interaction,” indicating the continuous cycle of input, processing, and feedback within the system. This flowchart provides a clear and concise overview of the system's operation, from the initial user input to the final game output and feedback, clarifying the flow of information and control within the immersive gaming system.

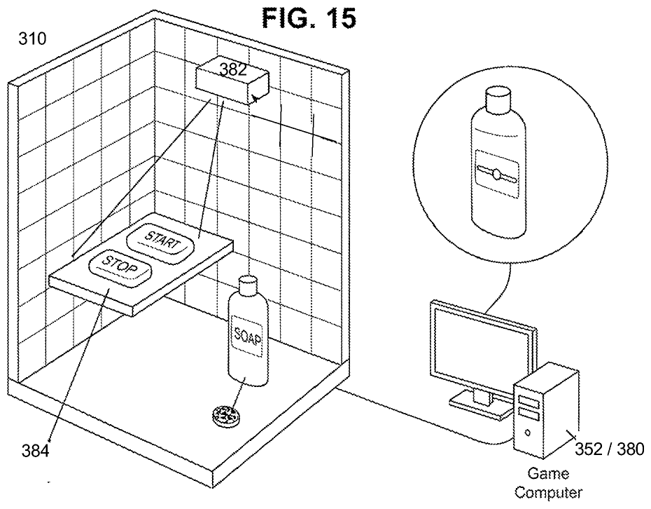

FIG. 15 illustrates the setup of a hidden mini projector 382 and a projection mapping system 380 within the shower enclosure 310 according to an embodiment of the present invention. The figure depicts the mini projector 382, concealed within a compartment, such as a layer of shelving in a corner of the shower enclosure 310. The projector is shown projecting onto physical objects located on a lower shelf or other designated surface within the enclosure, such as soap bars, shampoo bottles, or other surfaces.

The figure depicts the connection between the hidden mini projector 382 and the game computer 350, showing how the computer sends video signals to the projector. It also depicts the projected image overlaid on the physical objects. For example, the figure might show instructions projected onto a bar of soap, transforming it into a touch-sensitive interface, or a minigame interface projected onto a shampoo bottle.

The figure includes a close-up view of a projected interface 384 on a physical object, demonstrating how the projection mapping creates a seamless integration between the virtual and physical worlds. It also depicts different types of projected interfaces 384, such as touch-sensitive buttons, sliders, or interactive displays, showing the versatility of the projection mapping system 380. The figure depicts the discreet and integrated nature of the projector placement, maintaining the aesthetic of a normal shower while providing advanced interactive capabilities.

This figure illustrates the use of projection mapping to create interactive elements on existing objects within the shower enclosure 310, expanding the range of input and feedback mechanisms beyond the physical controls and the main display. It shows how the hidden mini projector 382 and the game computer 350 work together to create these projected interfaces 384, enhancing the immersive and interactive nature of the gaming experience while maintaining a clean and uncluttered shower environment.

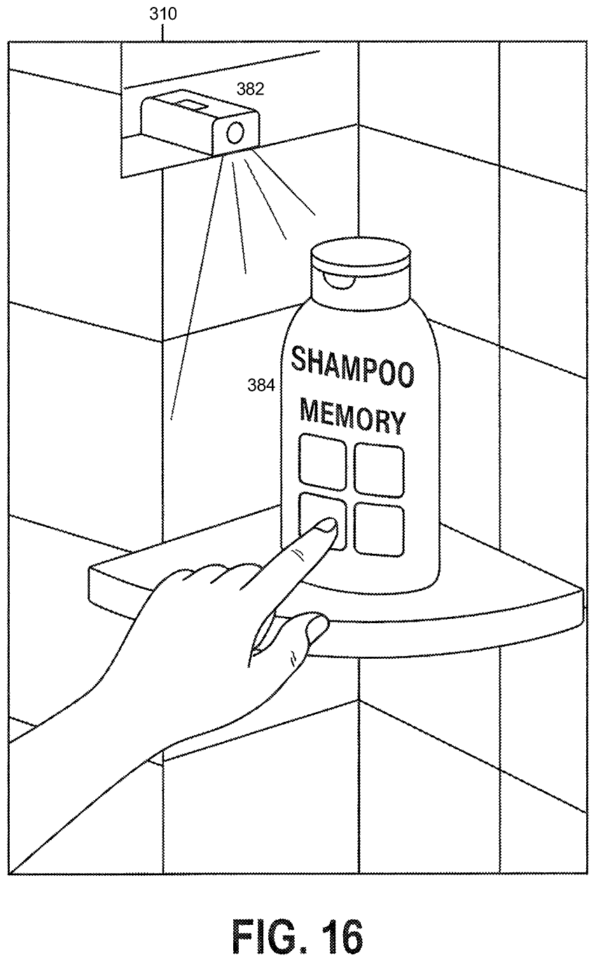

FIG. 16 depicts a specific example of a projected interface 384 on a physical object within the shower enclosure 310, according to an embodiment of the present invention. The figure illustrates the use of a mini projector 382 to project a game interface onto the surface of a shampoo bottle resting on a shelf.

In this embodiment, the projected interface 384 comprises a Simon-style memory game, where the player must touch the correct sequence of illuminated buttons. The figure shows the projected buttons appearing directly on the surface of the shampoo bottle, with one button highlighted to indicate the active or selected target.

The figure also shows the user's hand interacting with the projected interface 384, demonstrating how the system detects and responds to touch or proximity interactions on the projected display 384 area. The mini projector 382 is shown mounted above or beside the shelf, casting the projection downward at an angle that ensures visibility and alignment with the bottle surface.

FIG. 16 thus demonstrates the ability of the immersive gaming system to create dynamic, interactive interfaces on existing real-world objects using projection mapping. This allows for the transformation of everyday shower items into interactive game elements without requiring physical modification of the objects themselves. The figure further illustrates the seamless integration of the virtual interface with the physical environment, enhancing the immersive experience while preserving the aesthetic of a standard shower enclosure 310.

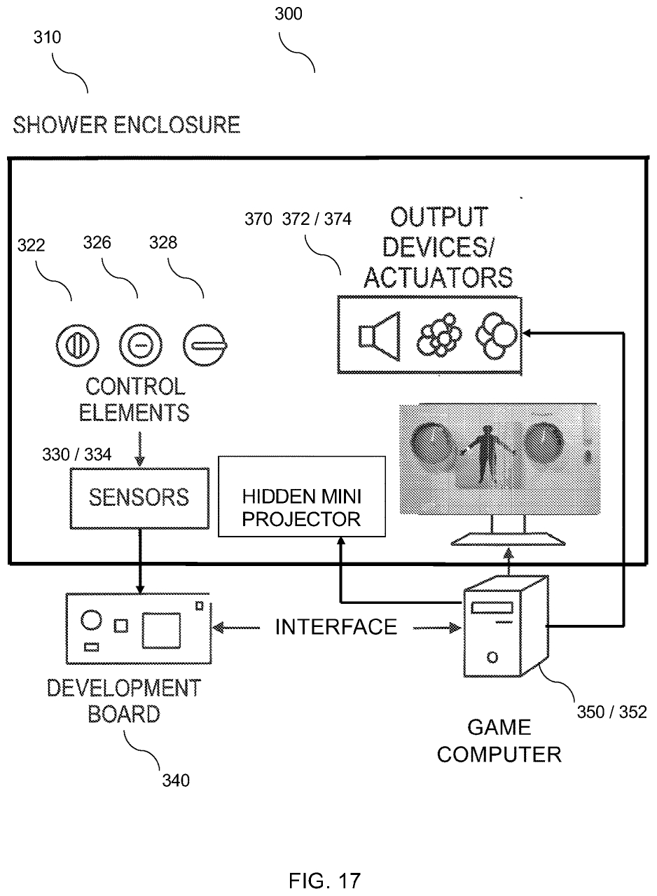

FIG. 17 depicts the overall system diagram (e.g., as shown in FIG. 3) to include the projection mapping components, with the projector hidden within the shower enclosure 310, according to an embodiment of the present invention. It depicts the connection between the game computer 350, the hidden mini projector 382, and the physical objects within the shower enclosure 310.

The figure adds the hidden mini projector 382 to the system diagram, showing its concealed placement within a designated area of the shower enclosure 310, such as a shelf unit. It also depicts its connection to the game computer 350. It shows the path of the projected image from the projector to the physical objects, indicating how the projection mapping creates a combined virtual-physical interface within the shower.

This system diagram shows how the projection mapping system 380 integrates with the other components of the immersive gaming system. It depicts how the game computer 350 controls both the main display and the hidden mini projector 382, coordinating the visual output and creating a unified gaming experience. This figure provides a complete overview of the system, including the projection mapping capabilities and the discreet projector placement, depicting the versatility and multi-faceted nature of the invention while maintaining a clean and functional shower environment.

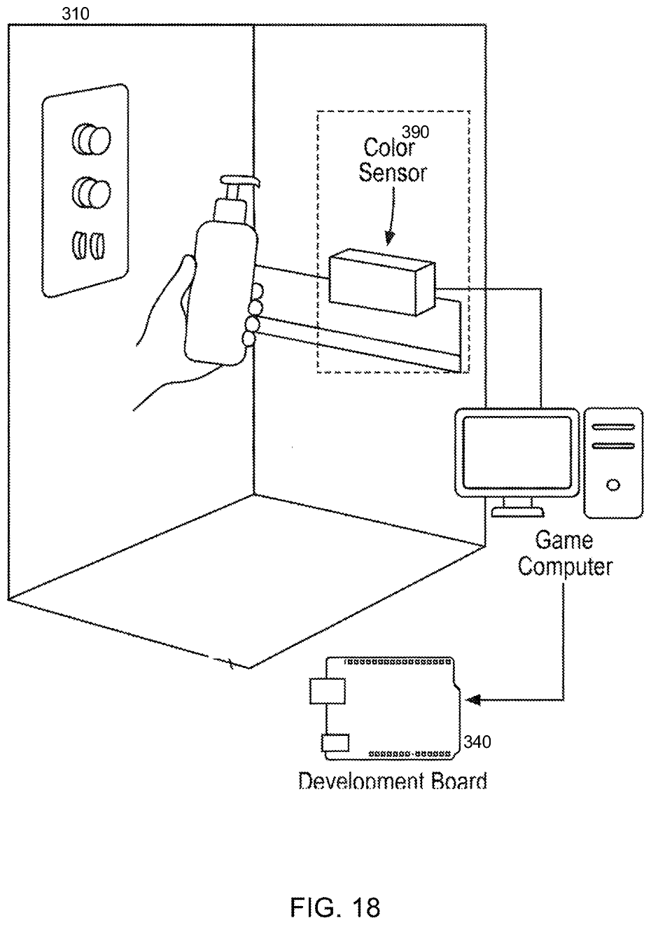

FIG. 18 illustrates the integration of a color sensor 390 into the immersive gaming system according to an embodiment of the present invention. The figure depicts the color sensor 390, hidden behind a designated area of the shower enclosure 310 (e.g., behind a panel or shelf), connected to the development board 340. It also depicts the user presenting colored objects, such as shampoo bottles, to the designated location in front of the sensor.

The figure shows the connection between the color sensor 390 and the development board 340, showing how the sensor transmits color data to the microcontroller 346. It depicts the sensor detecting the color of a shampoo bottle being presented and sending the corresponding color information to the development board 340. The figure shows the hidden nature of the sensor, maintaining the aesthetic of a normal shower environment.

This figure shows how the color sensor 390 is used to detect and identify colored objects presented by the user. It explains how this color information is then used as input for the game, enabling color-based puzzles and challenges.

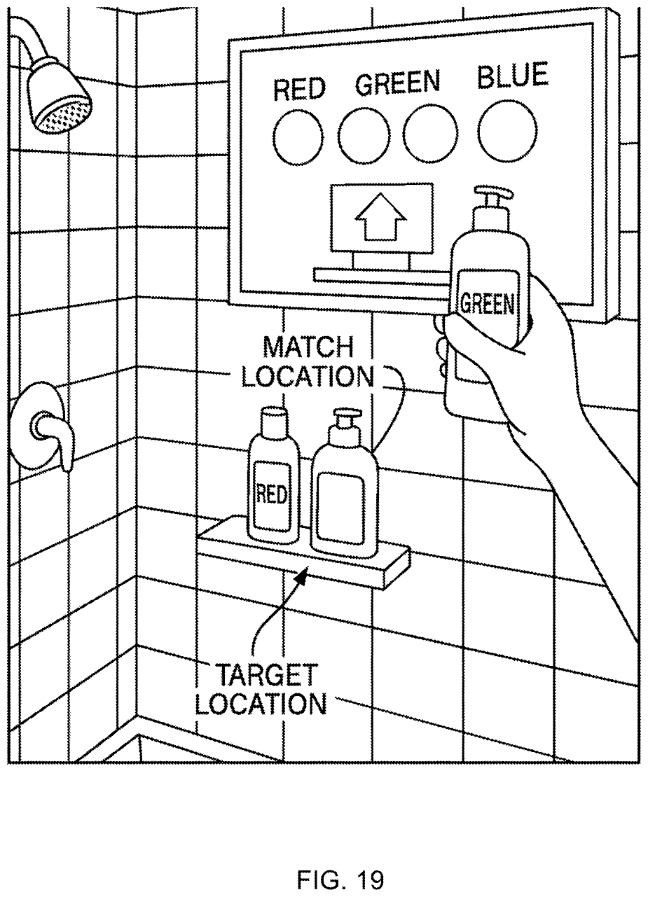

FIG. 19 provides a specific example of a color-based puzzle within the game, according to an embodiment of the present invention. It shows the game display presenting a sequence of colors, acting as a “combination” that the user must replicate.

The figure depicts the game display showing the color sequence. The sequence could be presented visually, or it could be part of a narrative or clue within the game. The figure also depicts a visual representation of the target location where the user needs to present the colored objects.

The figure depicts the interaction between the user and the color-based puzzle. It depicts the user holding different colored shampoo bottles, attempting to match the sequence shown on the display. It shows the challenge of remembering and replicating the correct color order, adding an element of puzzle-solving to the game.

This figure provides a concrete example of how the color sensor 390 can be used to create interactive puzzles within the game. It demonstrates the potential for using color recognition to create engaging challenges and advance the game narrative, similar to escape room puzzles.

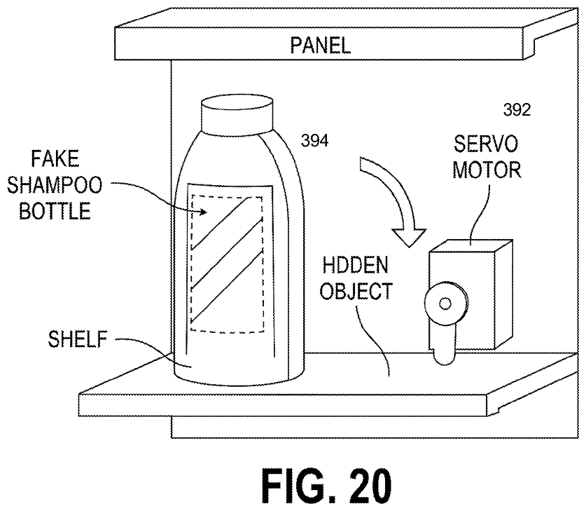

FIG. 20 illustrates the activation of a hidden mechanism 394 triggered by the successful completion of a color-based puzzle according to an embodiment of the present invention. It depicts a hidden servo motor 392 causing a fake shampoo bottle 394 to rotate, revealing a hidden object or code.

The figure depicts the fake shampoo bottle 394 on a shelf, seemingly ordinary. However, the figure also depicts a hidden servo motor 392 connected to the bottle, controlled by the development board 340. It depicts the bottle partially rotated, revealing a hidden object, such as a key, a code, or another clue.

The figure shows the connection between the successful completion of the color puzzle (detected by the color sensor 390) and the activation of the servo motor 392. It depicts how the development board 340 triggers the servo motor 392 to rotate the bottle, revealing the hidden object. The figure shows the surprise and discovery element, similar to finding a hidden clue in an escape room.

This figure depicts the integration of physical mechanisms with the color-based puzzles, adding an extra layer of interactivity and excitement to the game. It demonstrates the potential for creating unexpected events and discoveries, enhancing the immersive and engaging nature of the gaming experience.

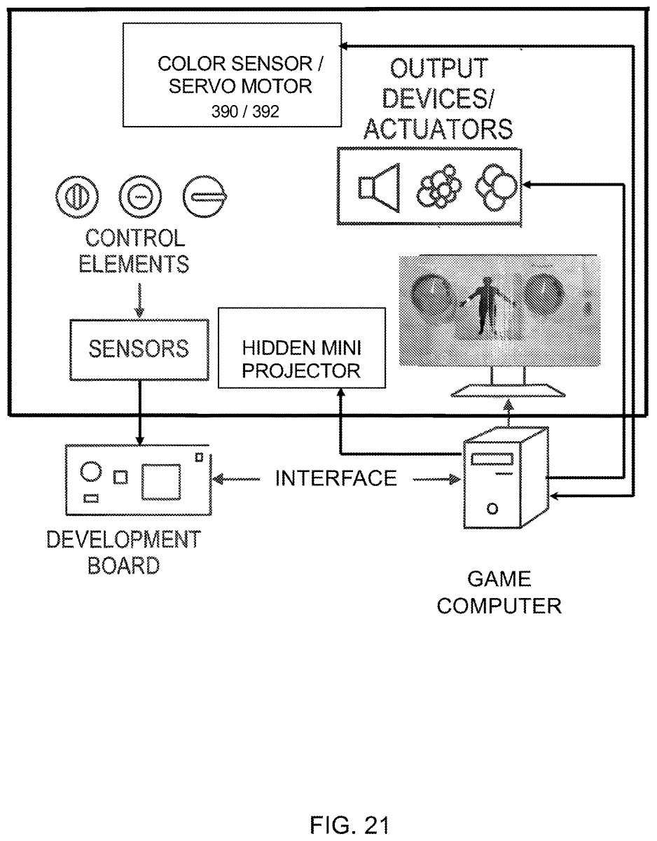

FIG. 21 updates the overall system diagram (e.g., as shown in FIG. 3) to include a color sensor 390 and a hidden servo motor 392, according to aspects of the present invention. It depicts the connections between these new components, the development board 340, and the game computer 350.

The figure adds the color sensor 390 and the servo motor 392 to the system diagram, showing their connections to the development board 340. It also depicts the interaction between the color sensor 390, the development board 340, the game computer 350, and the servo motor 392, illustrating the sequence of events from color detection to mechanism activation.

This updated system diagram shows how the escape room-themed elements integrate with the other components of the immersive gaming system. It depicts how the color sensor 390 and the servo motor 392 expand the range of input and feedback mechanisms, adding new dimensions to the gaming experience. This figure provides a complete overview of the system, including the escape room features, depicting the versatility and multi-faceted nature of the invention.

While the above description contains many specifics and certain exemplary embodiments have been described and shown in the accompanying drawings, it is to be understood that such embodiments are merely illustrative of, and not restrictive on, the broad invention, and that this invention is not to be limited to the specific constructions and arrangements shown and described, since various other modifications may occur to those ordinarily skilled in the art, as mentioned above. The invention includes any combination or sub-combination of the elements from the different species and/or embodiments disclosed herein.

I claim:

1. A system for immersive gaming, comprising:
a physical enclosure configured to resemble a real-world environment;
a plurality of input devices disposed within the physical enclosure, each input device having an outward appearance simulating a respective functional element native to the real-world environment while internally coupling to a sensor configured to generate an electrical signal responsive to user interaction;
a processing unit communicatively coupled to the sensors and configured to convert the electrical signals to data representative of the user interaction;
a computer communicatively coupled to the processing unit, the computer configured to execute software that maps the data to in-game actions based on a configurable input mapping and renders a game environment responsive to the user interaction; and
a display configured to present the game environment.

2. The system of claim 1, wherein the physical enclosure comprises a shower enclosure, and the plurality of input devices includes at least one rotary control disguised as a shower knob and at least one pushbutton control disguised as a soap dispenser.

3. The system of claim 2, wherein the at least one rotary control is coupled to a potentiometer via a custom adapter, and the at least one pushbutton control comprises a momentary push-button switch disposed behind a soap dispenser facade.

4. The system of claim 1, wherein the processing unit comprises a microcontroller development board including at least one analog-to-digital converter, and the processing unit communicates with the computer via a serial USB interface.

5. The system of claim 1, wherein the configurable input mapping is reconfigurable to support a plurality of different game genres using the same input devices without hardware modification.

6. The system of claim 1, further comprising at least one output device disposed within or proximate to the physical enclosure and configured to produce a physical environmental effect coordinated with a game event.

7. The system of claim 1, further comprising a projector concealed within the physical enclosure and communicatively coupled to the computer, the computer configured to project interactive visual elements onto a physical object within the enclosure, the interactive visual elements responsive to user interaction.

8. The system of claim 1, further comprising a color sensor disposed within the physical enclosure and configured to detect a color of a physical object presented by a user, and an actuator communicatively coupled to the processing unit and configured to actuate a concealed object within the enclosure responsive to a game condition based on the detected color.

9. The system of claim 8, wherein the actuator comprises a servo motor configured to rotate the concealed object to reveal a hidden element.

10. A method for immersive gaming, comprising:
receiving, at a processing unit, electrical signals from a plurality of sensors disposed within a physical enclosure that resembles a real-world environment, each sensor coupled to a respective input device having an outward appearance simulating a functional element native to the real-world environment;
converting, by the processing unit, the electrical signals to data representative of user interaction with the input devices;
mapping, by a computer, the data to in-game actions based on a configurable input mapping;
rendering a game environment responsive to the in-game actions; and
presenting the game environment on a display.

11. The method of claim 10, wherein the physical enclosure comprises a shower enclosure, and receiving the electrical signals comprises receiving signals from at least one potentiometer coupled to a shower knob via a custom adapter and at least one push-button switch disposed behind a soap dispenser facade.

12. The method of claim 10, further comprising reconfiguring the configurable input mapping to support a different game genre using the same input devices without hardware modification.

13. The method of claim 10, further comprising projecting, by a projector concealed within the physical enclosure, interactive visual elements onto a physical object within the enclosure.

14. The method of claim 10, further comprising detecting, by a color sensor disposed within the physical enclosure, a color of a physical object presented by a user, and actuating a concealed mechanism responsive to a game condition based on the detected color.

15. The method of claim 10, further comprising controlling at least one output device to produce a physical environmental effect within the physical enclosure coordinated with a game event.

16. A non-transitory computer-readable medium storing instructions that, when executed by one or more processors of a computer, cause the computer to:
receive data from a processing unit communicatively coupled to a plurality of sensors disposed within a physical enclosure that resembles a real-world environment, each sensor coupled to a respective input device having an outward appearance simulating a functional element native to the real-world environment;
map the data to in-game actions based on a configurable input mapping;
render a game environment responsive to user interaction with the input devices; and
present the game environment on a display.

17. The non-transitory computer-readable medium of claim 16, wherein the configurable input mapping is reconfigurable to support a plurality of different game genres using the same input devices without hardware modification.

18. The non-transitory computer-readable medium of claim 16, wherein the instructions further cause the computer to transmit video signals to a projector concealed within the physical enclosure to project interactive visual elements onto a physical object within the enclosure.

19. The non-transitory computer-readable medium of claim 16, wherein the instructions further cause the computer to control at least one output device to produce a physical environmental effect within the physical enclosure coordinated with a game event.

20. The non-transitory computer-readable medium of claim 16, wherein the instructions further cause the computer to receive color data from a color sensor via the processing unit and activate an actuator responsive to a game condition based on the color data.
